(19) United States
(12) Patent Application Publication
(10) Pub. No.: US 2012/0085146 A1
(43) Pub. Date: Apr. 12, 2012

(54) PARTICULATE MATTER DETECTION SENSOR

(75) Inventors: Eriko MAEDA, Okazaki-city (JP); Takehito Kimata, Kariya-city (JP)

(73) Assignee: DENSO CORPORATION, Kariya-city (JP)

(21) Appl. No.: 13/242,210

(22) Filed: Sep. 23, 2011

(30) Foreign Application Priority Data
Oct. 12, 2010 (JP) 2010-229705

(51) Int. Cl. G01N 27/00

(52) U.S. Cl. 73/23.31

(57) ABSTRACT

A PM-sensor having a sensor element is provided to an exhaust pipe. The sensor element has a concaved chamber on a particulate matter detection surface of an insulating substrate body, and a detection electrode formed on a bottom surface of the chamber. An insulating protecting layer covers an upper opening of the concaved chamber. The insulating protecting layer has a plurality of penetrating holes through which only particulate matter to be detected can passes.

### CROSS-REFERENCE TO RELATED APPLICATION

This application is based on Japanese Patent Application No. 2010-229705 filed on Oct. 12, 2010, the disclosure of which is incorporated herein by reference.

### FIELD OF THE INVENTION

The present invention relates to a particulate matter detection sensor for detecting particular matters contained in exhaust gas, which is applied to an exhaust gas purifying system of an internal combustion engine.

### BACKGROUND OF THE INVENTION

A diesel engine installed on a vehicle is provided with a diesel particulate filter DPF in an exhaust pipe in order to capture diesel particulate matters PM which includes carbon particulates Soot and soluble organic fractions SOF. Generally, the DPF is made of porous ceramics which has high heat-resistance property. When exhaust gas passes through a plurality of pores, the PM are captured on partition walls of the DPF.

When the captured PM quantity exceeds a specified value, it is likely that the pores are clogged and no PM is captured. Thus, the DPF is periodically regenerated to recover its PM capturing capacity. For regenerating the DPF, a differential pressure between upstream and downstream of the DPF is utilized. A differential pressure sensor is disposed to detect the differential pressure. High-temperature combusted gas generated by a heater or a post-fuel injection is introduced into the DPF to burn the captured PM.

JP-59-197847A shows an electric-resistance-type sensor which can directly detect the PM in exhaust gas. This sensor has an insulating substrate on which a pair of conductive electrodes is formed. A heating element is provided on a reverse surface of the substrate or interior of the substrate. In a case that the sensor is disposed downstream of the DPF, the sensor can detect the PM which has passed through the DPF. Thus, this sensor can detect a malfunction of the DPF, such as a crack and a breakage. In a case that the sensor is disposed upstream of the DPF, the sensor can detect the PM quantity flowing into the DPF. In stead of a differential pressure sensor, this sensor can be utilized to determine a regeneration timing of the DPF.

FIG. 7A shows a conventional electric-resistance-type sensor. A pair of electrodes 101, 102 is disposed on a surface of an insulating substrate 100 as a detector portion. A heater electrode 103 and an insulating plate 104 are disposed on a reverse surface of the substrate 100 as a heater portion. This sensor utilizes a fact that carbon particulates (Soot) have conductivity. When the PM are accumulated between the electrodes 101 and 102, the sensor detects a variation in electric resistance between the electrodes 101, 102.

The heater portion heats the detector portion up to a specified temperature (for example, 400° C.-600° C.). After measuring the electric resistance between the electrodes 101, 102, the heater portion burns the adhering PM to recover the detection capacity of the sensor. Further, except the detector portion of the substrate 100 and a terminal portion 105, the substrate 100 is covered with an airtight insulating layer 106.

JP-2009-85959A shows another sensor which has a protect layer on detection electrodes to protect the detection electrode system from corrosion or mechanical damage due to exhaust gas. The detection electrodes are formed on the insulating layer by screen printing, for example. Further, by using physical vapor deposition (PVD) or chemical vapor deposition (CVD), a pair of detection electrodes are formed, in which a clearance therebetween is significantly small (for example, 20 μm-40 μm).

JP-2006-266961A shows another sensor in which a soot detection electrode is disposed between a pair of detection electrodes 107 and 108 as shown in FIG. 7B. The soot detection electrode is made of porous conductive material, such as cermet containing metal and ceramics. According to this configuration, even if no soot is adhering, minute electric current flows between a pair of the conductive electrodes. Further, some soot are captured on a surface of the soot detection electrode and in its porous. Thus, this sensor can detect the variation in electric resistance according to adhering soot quantity for a long period.

The electric-resistance-type sensor has advantages in its simple configuration and stable output relative to another type of the sensor.

The conventional sensor shown in FIG. 7A is accommodated in a sensor cover having vent holes to be disposed on an outer wall surface of an exhaust pipe. In a case that this sensor is utilized to detect a malfunction of the DPF, the pair of the electrodes 101 and 102 is arranged in such a manner as to confront exhaust gas flow in order to easily capture the PM contained in exhaust gas. The detected PM are usually suspended particulate of 10 μm or less. When detecting a malfunction of the DPF, it is necessary for the sensor to detect the particulate matters of 2.5 μm or less.

When the engine is off, the PM contained in exhaust gas accumulated in the exhaust pipe may adhere on an inner wall surface of the exhaust pipe. Similarly, when the exhaust gas in the exhaust pipe is cooled along with the engine, moisture contained in the exhaust gas may be condensed to adhere on the inner wall surface of the exhaust pipe. If the adhering PM and/or the condensed water is removed from the inner wall surface of the exhaust pipe during an engine running, it is likely that large particulates of the PM and the condensed water may collide with the detector portion of the sensor.

If the large PM adheres to a detector portion of the sensor, the sensor hardly measures the PM quantity passed through the DPF with high accuracy. If the condensed water adheres to the detector portion of the sensor, the accuracy of the sensor is deteriorated. If the condensed water adheres to the sensor of high temperature, it is likely that the sensor element may be cracked due to thermal stress.

Although the protect layer shown in JP-2009-85959A effectively protects the surface of the detection electrode from mechanical damages, it hardly eliminates any influences of adhering particulates and condensed water to restrict erroneous detection.

Also in the sensor shown in JP-2006-266961A, when the large particulate matters and the condensed water adhere to the soot detection electrode, the electric resistance is easily varied.

As described above, the conventional sensors are not configured well enough to restrict the thermal damages due to the condensed water and the detection errors due to the large particulates of the PM and the condensed water.

### SUMMARY OF THE INVENTION

The present invention is made in view of the above matters, and it is an object of the present invention to provide a particulate matter detection sensor, which is able to accurately detect particulate matters contained in exhaust gas and to promptly detect a malfunction of a diesel particulate filter.

According to the present invention, a particulate matter detection sensor includes a sensor element having an insulating substrate body on which a detection electrode is provided for detecting a particulate matter contained in a subject measured gas. The sensor element has a particulate matter detector portion which includes a detection surface on a surface of the insulating substrate body, a concaved chamber on the detection surface, a pair of detection electrodes provided on a bottom surface of the concaved chamber, and an insulating protecting layer covering the concaved chamber. Further, the insulating protecting layer has a plurality of penetrating holes through which only particulate matter to be detected can pass.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1A is an exploded perspective view of a sensor element according to a first embodiment;

FIG. 1B is a partially enlarged perspective view showing an essential portion of the sensor element;

FIG. 1C is a cross sectional view showing the sensor element; FIG. 2A is an enlarged cross sectional view showing a situation in which a PM-sensor is provided to an exhaust pipe;

FIG. 2B is a schematic view showing an exhaust gas purifying system of a diesel engine;

FIG. 3A is a cross sectional view for explaining a manufacturing method of a PM-sensor;

FIG. 3B is a cross sectional view for explaining a configuration of an essential portion of a sensor element;

FIG. 4 is an exploded perspective view of a sensor element according to a second embodiment;

FIG. 5A is a cross sectional view for schematically showing a sensor element for explaining an advantage of the present invention;

FIGS. 5B and 5C are perspective views of a conventional sensor element; FIG. 6A is an exploded perspective view of a sensor element according to a third embodiment;

FIG. 6B is a plain view of a porous insulating protecting layer according to a fourth embodiment;

FIG. 6C is a distribution chart showing a relationship between a diameter of a particulate matter and an accumulated particulate matter amount;

FIG. 7A is an exploded perspective view for schematically showing a conventional sensor element; and

FIG. 7B is a schematic view for explaining a configuration of a conventional sensor element.

### DETAILED DESCRIPTION OF EMBODIMENTS

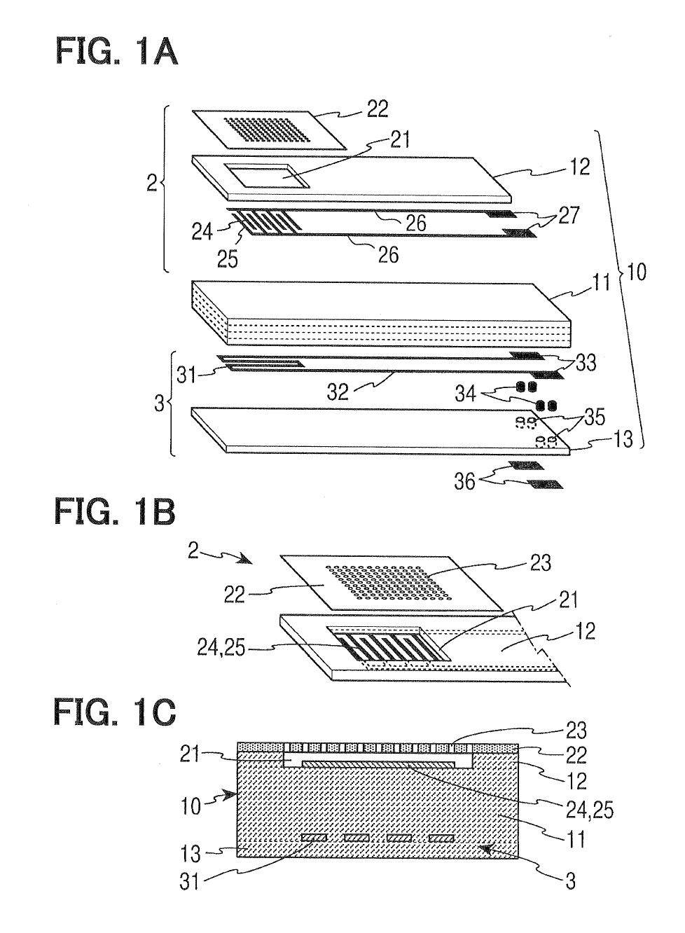

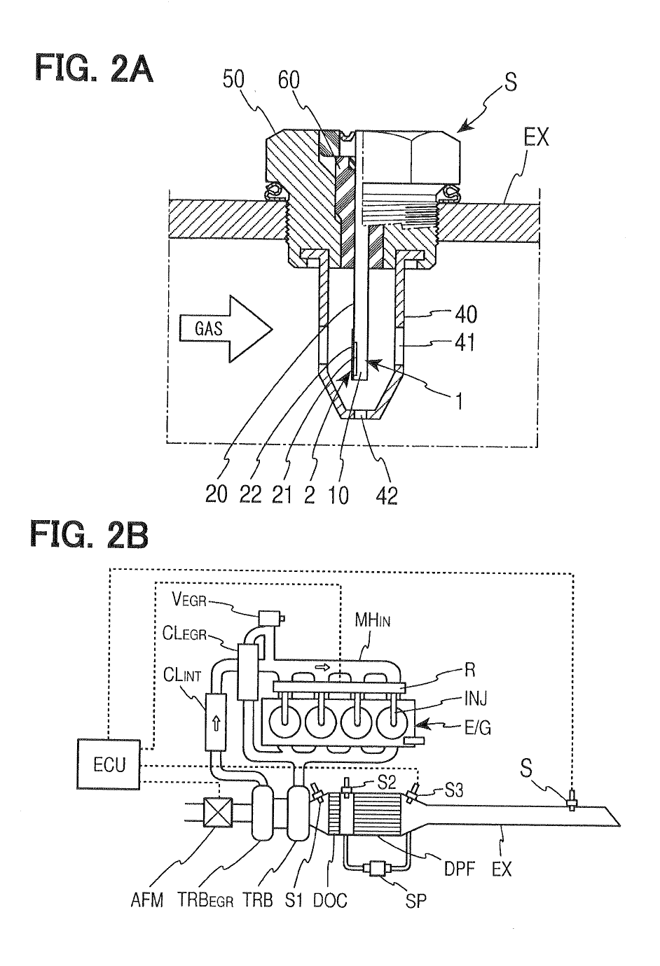

A first embodiment of the present invention will be described hereinafter. FIGS. 1A to 1C schematically show a configuration of a sensor element 1 of a particulate matter detection sensor. The particulate matter detection sensor is referred to as a PM-sensor “S”, hereinafter. FIG. 2B is a schematic view showing a diesel engine E/G. FIG. 2A is a cross sectional view showing the PM-sensor “S” mounted on an exhaust pipe EX of the engine E/G.

The engine E/G is a direct injection engine. A fuel injector INJ injects fuel, which is supplied from a common-rail “R”, into a combustion chamber. The common-rail “R” accumulates high-pressure fuel pressurized by a high-pressure pump. The PM-sensor “S” is arranged downstream of a diesel particulate filter DPF in the exhaust pipe EX. An electronic control unit ECU controls the PM-sensor “S” and other parts of the engine E/G. The ECU has a function for detecting a malfunction in the PM-sensor “S”.

Referring to FIG. 2B, a configuration of the engine E/G will be described hereinafter. A turbine TRB is provided in an exhaust manifold MHEX and a compressor TRBCGR compresses intake air to introduce the compressed air into an intake manifold MHIN through an intercooler CLRINT. A part of exhaust gas discharged from the exhaust manifold MHEX is recirculated into the intake manifold MHIN through an EGR valve VEGR and an EGR cooler CLREGR.

In an exhaust pipe EX connected to the exhaust manifold MHEX, a diesel oxidation catalyst DOC and a diesel particulate filter DPF are provided to treat the exhaust gas. While the exhaust gas flows through the diesel oxidation catalyst DOC, unburned hydrocarbon (HC), carbon monoxide (CO) and nitric monoxide (NO) are oxidized. While the exhaust gas flows through the diesel particulate filter DPF, the Soot, the SOF and the PM are captured by the diesel particulate filter DPF.

The diesel oxidation catalyst DOC is comprised of monolith made of cordierite on which oxidation catalyst is supported. When the diesel particulate filter DPF is compulsorily regenerated, the diesel particulate filter DPF increases the exhaust gas temperature or removes the SOF components in the PM. Nitrogen dioxide (NO₂) generated by oxidizing nitrogen monoxide (NO) is used as oxidizing agent which oxidizes the PM accumulated on the diesel particulate filter DPF.

The diesel particulate filter DPF has well known configuration of wall-flow type. Alternatively, the diesel oxidation catalyst DOC and the diesel particulate filter DPF are configured from a single integrate piece structure.

A differential pressure sensor SP is provided to the exhaust pipe EX to monitor the PM amount accumulated on the diesel particulate filter DPF. The differential pressure sensor SP communicates to upstream and downstream of the diesel particulate filter DPF so as to output a signal according to its differential pressure. Temperature sensors S1, S2, and S3 are respectively arranged upstream of the diesel oxidation catalyst DOC and upstream and downstream of the diesel particulate filter DPF.

The control unit ECU monitors active condition of the diesel oxidation catalyst DOC and PM-capturing condition of the diesel particulate filter DPF based on the signals from the above sensors. When the captured PM quantity exceeds an allowable value, the control unit ECU performs a regeneration control in which a compulsory regeneration is conducted to burn the PM. Furthermore, the control unit ECU receives various detection signals from sensors, such as an airflow meter AFM, an engine coolant temperature sensor, an engine speed sensor, a throttle position sensor and the like. Based on these detection signals, the control unit ECU computes a fuel injection quantity and a fuel injection timing to perform a fuel injection control.

As shown in FIG. 2A, the PM-sensor “S” has a cylindrical housing 50 which is threadably engaged with the exhaust pipe EX. The housing 50 holds an upper portion of a sensor element 1 which is inserted in a cylindrical insulator 60. A lower portion of the sensor element 1 is located in a cover 40 which is connected to a lower end portion of the housing 50 in such a manner as to protrude interior of the exhaust pipe EX. The cover 40 has apertures 41, 42 which respectively penetrate its side wall and bottom wall. The exhaust gas passed through the diesel particulate filter DPF, that is, the exhaust gas containing the PM flows into the cover 40 through these apertures 41, 42.

The PM-sensor “S” has the sensor element 1 which detects the PM passed through the diesel particulate filter DPF. As shown in FIG. 2, the sensor element 1 has a rectangular parallelepiped insulating base 10 on which a PM detector surface 20 is defined. A PM detector portion 2 is provided on the PM detector surface 20. The PM detector portion 2 has a chamber 21 and a porous insulating protecting layer 22 which covers the chamber 21. A pair of detection electrodes (not shown in FIG. 2) is arranged on a bottom surface of the chamber 21 to capture the PM. The PM detector portion 2 of the sensor element 1 will be described in detail hereinafter.

As shown in FIG. 1A, the sensor element 1 has a rectangular insulating substrate 11 on which a pair of detection electrodes 24, 25 are printed. Further, a chamber forming layer 12 which defines the chamber 21 therein and the porous insulating protecting layer 22 are laminated on the detection electrodes 24, 25. On a bottom surface of the substrate 11, a heater portion 3 is laminated. The detection electrodes 24, 25 are comb-shaped electrodes which confront to each other. A pair of lead electrodes 26 extends from the detection electrodes 24, 25 to be connected to a pair of terminal portions 27 respectively.

The chamber forming layer 12 has the chamber 21 at a position which confronts the detection electrodes 24, 25. A longitudinal length of the chamber forming layer 12 is slightly shorter than that of the insulating substrate 11, so that the terminal portions 27 are exposed on the insulating substrate 11.

The heater portion 3 is comprised of an insulating layer 13 made of ceramics and a heater electrode 31 disposed thereon. The heater electrode 31 is printed on a bottom surface of the insulating substrate 11 right under the detection electrodes 24, 25. A pair of lead electrodes 32 extends from the heater electrode 31 to be connected to a pair of terminal portions 33. These terminal portions 33 are electrically connected to terminals 36 through conductive material 34 filled in through-holes 35. The heater electrode 31 receives electricity from a battery (not shown) through the terminals 36 and generates heat to heat the PM detector portion 2 at a specified temperature.

The insulating substrate body 10 of the sensor element 1 is comprised of an insulating substrate 11 having detection electrodes 24, 25 and an insulating layer 13 having the chamber forming layer 12 and a heater electrode 31. The insulating substrate 11, the chamber forming layer 12 and the insulating layer 13 are preferably made of ceramic material, such as alumina ceramics, silicon carbide, and silicon nitride. These ceramic materials are formed into a specified shape by doctor blade method.

As shown in FIGS. 1B and 1C, the detection electrodes 24, 25 are exposed on a bottom surface of a chamber 21. The porous insulating protecting layer 22 covers an upper opening of the chamber 21. The porous insulating protecting layer 22 is made of ceramic material having multiple penetrating holes 23. These penetrating holes 23 are formed in such a manner that the particulate matters PM can pass therethrough. Large particulate patters PM which are larger than the penetrating holes 23 and the condensed water are not introduced into the chamber 21. Only small particulate matters PM pass through the penetrating holes 23 to be introduced into the chamber 21 and reach the detection electrodes 24, 25 which are located under the penetrating holes 23. The porous insulating protecting layer 22 is made of the same ceramic material as the insulating substrate body 10.

Generally, the particulate matters PM which should be detected have diameter in a range between 100 nm and 10 μm. It is important to detect the particulate matters PM of which diameter is not greater than 10 μm in order to restrict air pollution. In the present embodiment, the diameter of the penetrating holes 23 is not greater than 10 μm. The particulate matters PM of large diameter and the condensed water are not introduced into the detection electrodes 24, 25, so that erroneous detection can be avoided.

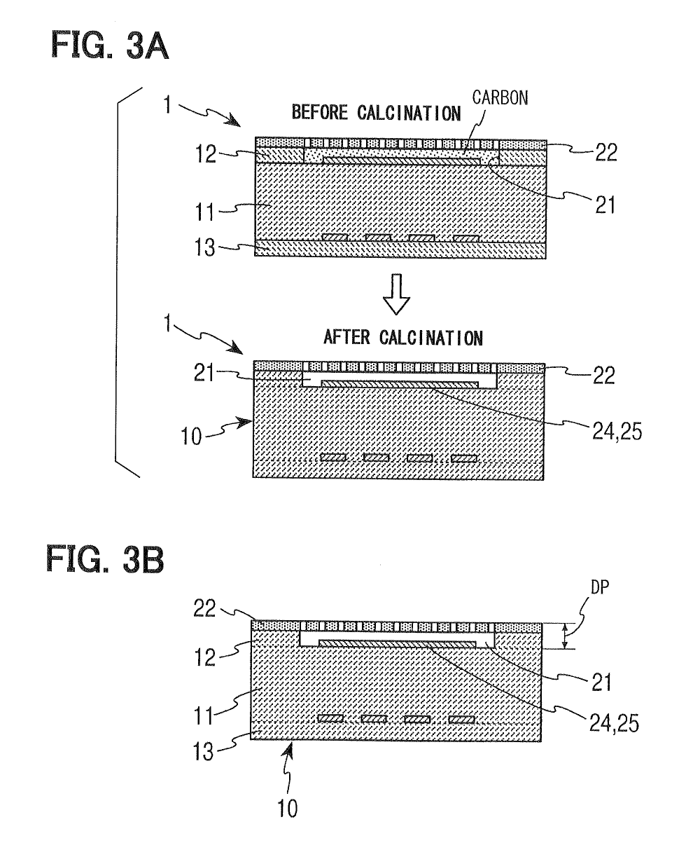

It should be noted that the diameter of the penetrating holes 23 can be arbitrarily set according to the diameter of the particulate matters PM which should be detected. For example, in a case that the particulate matters PM of which diameter is not greater than 2.5 μm should be detected, the diameter of the penetrating holes 23 is set less than or equal to 2.5 μm. Besides, a hydrophobic layer may be formed on a surface of the porous insulating protecting layer 22. Alternatively, the porous insulating protecting layer 22 may be made of material having water repellence, such as alumina ceramics. Referring to FIG. 3A, manufacturing method of the detector portion 2 will be described hereinafter. The detection electrodes 24, 25, the lead electrode 26 and the terminal 27 are formed on an upper surface of the insulating substrate 11 by screen printing, as shown in FIG. 1A. The chamber forming layer 12, the porous insulating layer 22, and the insulating layer 13 are laminated and united by calcination. The chamber 21 is filled with carbon on which the porous insulating protecting layer 22 is arranged. Then, the penetrating holes 23 are formed in the porous insulting protecting layer 22 by laser.

Then, by calcinating at a specified calcination temperature according to the martial of the insulating substrate body 10, the carbon in the chamber 21 is burned out. The camber 21 has the detection electrodes 24, 25 on its bottom surface. The porous insulating protecting layer 22 has a thickness of between 2.5 μm and 200 μm. If the porous insulating protecting layer 22 is thinner than 2.5 μm, it is likely that the porous insulating protecting layer 22 may have cracks in its manufacturing process. If the porous insulating protecting layer 22 is thicker than 200 μm, it is likely that the particulate matters PM may not pass through the penetrating holes 23. In order to avoid clogs of the penetrating holes 23, the porous insulating protecting layer 22 preferably has a thickness of between 2.5 μm and 20 μm.

Instead of perforating the porous insulating protecting layer 22 to form the penetrating holes 23 by means of laser, porous ceramic material containing carbon may be used to form the penetrating holes 23. In calcinating process, the contained carbon is burned out to form the penetrating holes 23.

As shown in FIG. 3B, the depth DP of the chamber 21 is sufficiently greater than a total value of the thickness of the detection electrodes 24, 25 and a diameter of the particulate matters PM which should be detected. Thereby, the particulate matters PM passed through the penetrating holes 23 can be floating in the chamber 21, so that the particulate matters PM can accumulate equally on between the detection electrodes 24, 25. The depth DP of the chamber 21 depends on the thickness of the chamber forming layer 12.

### Second Embodiment

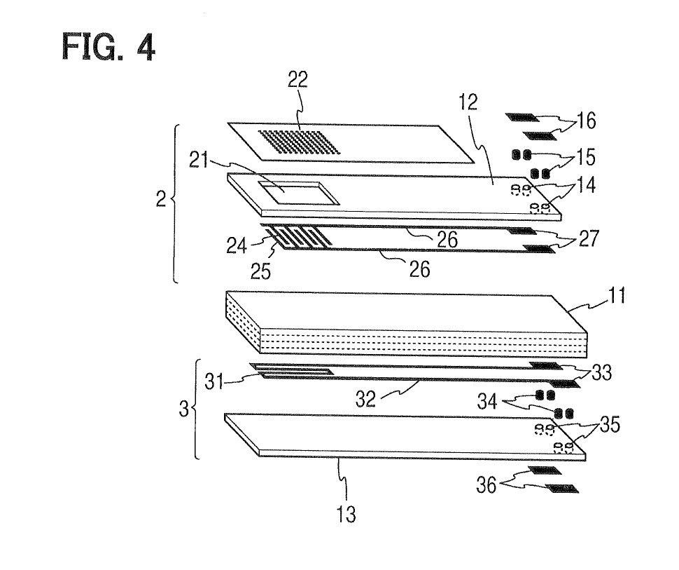

FIG. 4 shows a configuration of the sensor element 1 according to a second embodiment. The chamber forming layer 12 and the insulating substrate 11 have the same longitudinal length. The chamber forming layer 12 has a pair of through holes 14 which are filled with conducting material 15. On the upper surface of the chamber forming layer 12, a pair of terminals 16 is formed.

In the above embodiments, the detection electrodes 24, 25 are formed by printing conductive paste which contains platinum (Pt), for example. The heater electrode 31 is formed similarly. The heater electrode 31 is preferably made of W, Ti, Cu, Al, Ni, Cr, Pd, Ag, Pt, Au or alloy thereof, which has high migration resistance. A distance between the detection electrodes 24, 25 can be defined according to size of the particulate matters PM which should be detected. As the distance is shorter, the particulate matters PM can be detected earlier. According to the screen printing, the distance can be established between 50 μm and 200 μm. According to the physical vapor deposition (PVD) or the chemical vapor deposition (CVD), the distance can be established less than 50 μm.

### [Operation]

A basic operation of the PM-sensor “S” will be described hereinafter. As shown in FIGS. 2A and 2B, the sensor element 1 is provided to the exhaust pipe EX in such a manner that a detection surface 20 on which the PM detector portion 2 is formed confronts the exhaust gas flowing through the exhaust pipe EX, whereby the sensor element 1 surely captures the particulate matters PM. A base end portion of the PM-sensor “S”, which has the terminals 27, 36, is arranged outside of the exhaust pipe EX so that the terminals 27, 36 are electrically connected to the electronic control unit ECU. The exhaust gas emitted from the engine E/G flows into an interior of the PM-sensor “S” through an aperture 41 of a cover 40. After the exhaust gas is brought into contact with the sensor element 1, the exhaust gas flows out from the PM-sensor “S”.

The particulate matters PM which have flowed into the PM-sensor “S” pass through the penetrating holes 23 and adhere to the surface of the detection electrode 24, 25 and the surface of the insulating substrate 11. As shown in FIGS. 1A and 1B, since the detection electrodes 24, 25 are comb-shaped to define a specified clearance therebetween, the detection electrodes 24, 25 are not electrically connected to each other initially. The particulate matters PM include conductive soot particle. When the particulate matters PM are accumulated on the detection electrodes 24, 25 by a specified amount, the detection electrodes 24, 25 are electrically connected to each other. As the accumulated PM amount increases, the electric resistance between the detection electrodes 24, 25 decreases. The electric resistance between the detection electrodes 24, 25 varies according to the accumulated PM amount. Based on this relation, the particulate matters PM downstream of the diesel particulate filter DPF are detected so that it is determined whether the diesel particulate filter DPF has malfunction.

### [Advantage]

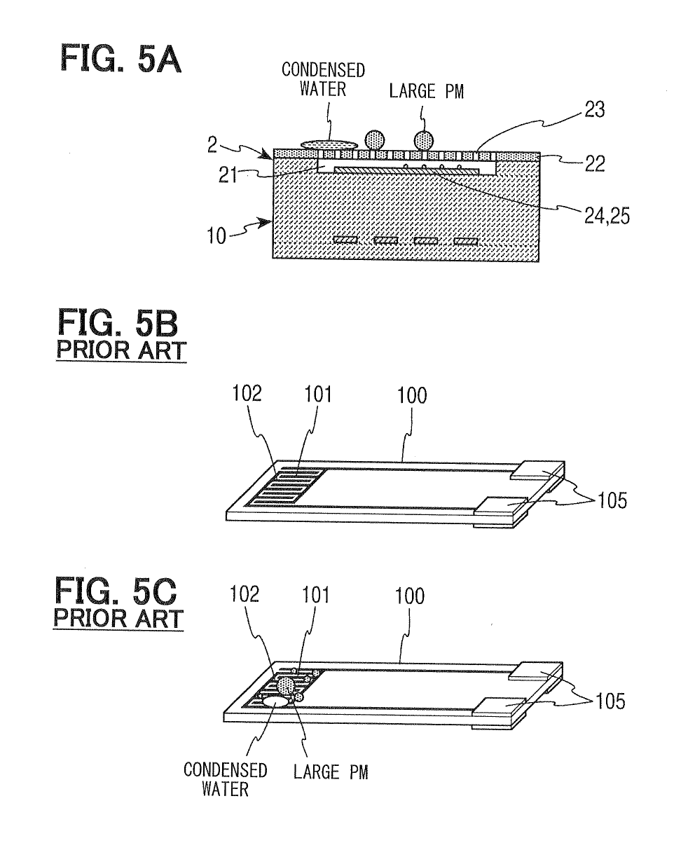

Referring to FIGS. 5A to 5C, advantages of the PM-sensor “S” according to the above embodiments will be described hereinafter. FIGS. 5B and 5C show a conventional sensor element. Comb-shaped detection electrodes 101, 102 are formed on a surface of an insulating layer 100. There is no cover on the detection electrodes 101, 102. Thus, if the large particulate matters PM and/or condensed water are introduced into the PM-sensor “S”, these particulate matters PM and/or condensed water easily adhere to the detection electrodes 101, 102. When the particulate matters PM and/or the condensed water adhere to a clearance between detection electrodes 101, 102 as shown in FIG. 5C, it is likely that the detection electrodes 101, 102 are erroneously connected to each other, which may cause an erroneous detection and a variation in detection value.

Meanwhile, according to the sensor element 1 of the above embodiments, as shown in FIG. 5A, the PM detector portion 2 is covered by the porous insulating protecting layer 22. Only the particulate matters PM which pass through the penetrating holes 23 can flow into the chamber 21. The large particulate matters PM and the condensed water can not pass through the penetrating holes 23. As the result, by monitoring the electric resistance between the detection electrodes 24, 25, only the subject particulate matters PM are detected with high accuracy. Further, it is restricted to generate crack in the sensor element due to thermal shock. After the particulate matters PM are detected, the heater 3 heats the accumulated particular matters PM to burn the same, so that the detection electrodes 24, 25 are regenerated.

### Third Embodiment

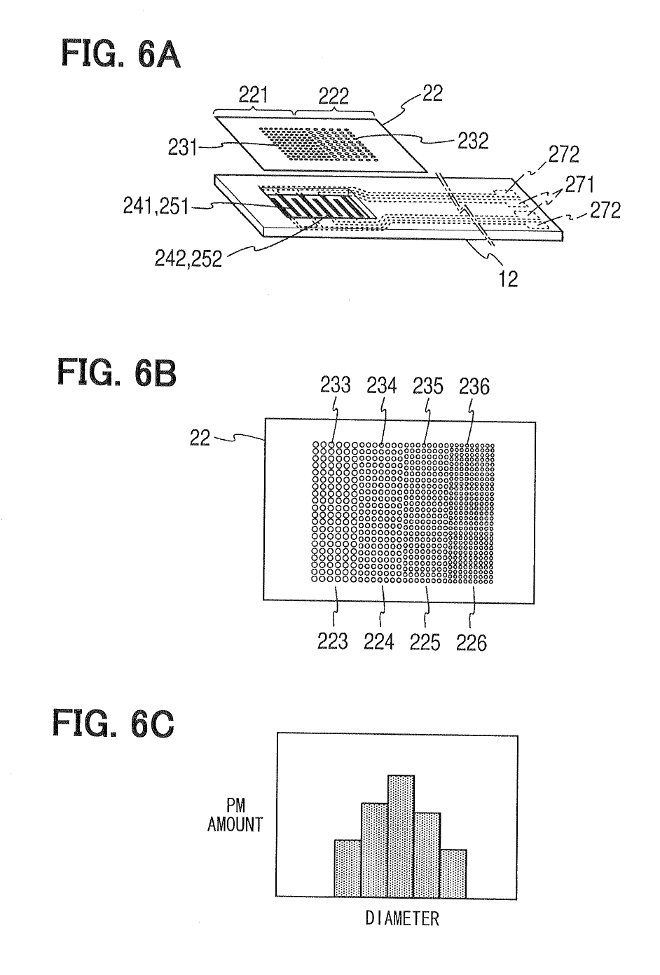

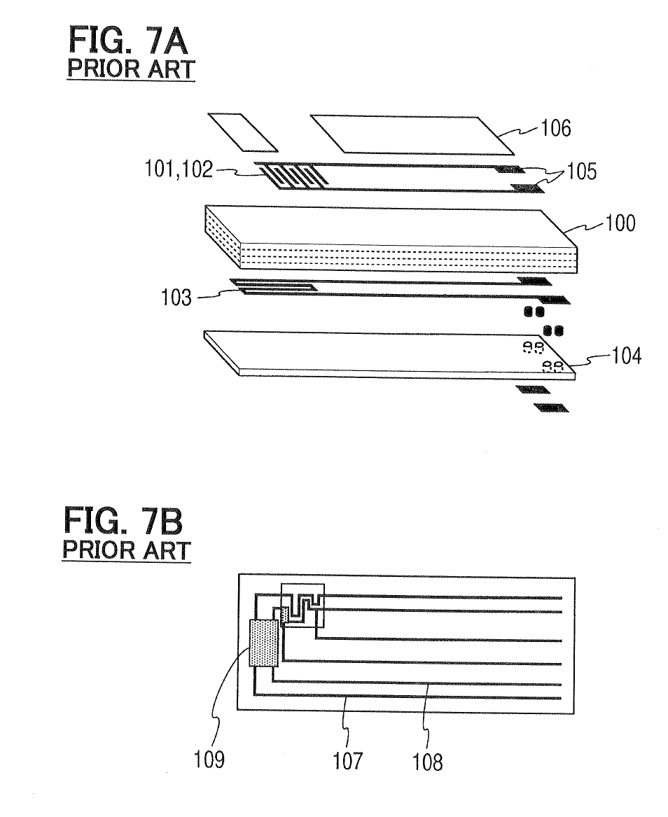

FIG. 6A shows a third embodiment of the present invention. In the present invention, the diameter of the penetrating holes 23 is partially varied. That is, small diameter penetrating holes 231 are formed at a left half 221 of the porous insulating protecting layer 22, and large diameter penetrating holes 232 are formed at a right half 222 of the porous insulating protecting layer 22. For example, the diameter of the small diameter penetrating holes 231 is not greater than 5 μm, and the diameter of the large diameter penetrating holes 232 is not greater than 10 μm. Further, detection electrodes 241, 251 corresponding to the small diameter penetrating holes 231 and detection electrodes 242, 252 corresponding to the large diameter penetrating holes 232 are respectively formed. Each of these electrodes is connected to a pair of terminals 271, 272. Thereby, a distribution of the particulate matters PM in the exhaust gas can be detected to improve an accuracy of the detection.

### Fourth Embodiment

FIG. 6B shows a fourth embodiment. The porous insulating protecting layer 22 is comprised of a first portion 223 to a fourth portion 226 at which a first penetrating holes 233 to a fourth penetrating holes 236 are respectively formed. The diameter of penetrating holes 233-236 are stepwise varied. The diameter of the first penetrating holes 233 is largest and the diameter of the fourth penetrating holes 236 is smallest. A pair of detection electrodes 24, 25 is provided to detect the particulate matters PM. By analyzing the detecting result, a distribution of particulate matters diameter can be obtained as shown in FIG. 6C.

The PM-sensor “S” may be arranged upstream of the diesel particulate filter DPF to detect the particulate matters PM flowing into the filter DPF.

What is claimed is:

1. A particulate matter detection sensor comprising:
a sensor element having an insulating substrate body on which a detection electrode is provided for detecting a particulate matter contained in a subject measured gas, wherein
the sensor element has a particulate matter detector portion which includes a detection surface on a surface of the insulating substrate body; a concaved chamber on the detection surface; the detection electrode provided on a bottom surface of the concaved chamber; and an insulating protecting layer covering the concaved chamber, and
the insulating protecting layer has a plurality of penetrating holes through which only particulate matter to be detected can pass.

2. A particulate matter detection sensor according to claim 1, wherein
a diameter of the penetrating holes is not greater than 10 μm.

3. A particulate matter detection sensor according to claim 1, wherein a diameter of the penetrating holes is not greater than 2.5 μm.

4. A particulate matter detection sensor according to claim 1, wherein
a distance between the detection electrodes and the insulating protecting layer is greater than a diameter of the particulate matter which is detected.

5. A particulate matter detection sensor according to claim 1, wherein the insulating protecting layer is a ceramic layer having the penetrating holes or a porous ceramic layer.

6. A particulate matter detection sensor according to claim 1, wherein
the insulating protecting layer is mainly made of oxide ceramics, carbide ceramics, or nitride ceramics.

7. A particulate matter detection sensor according to claim 1, wherein the penetrating holes are comprised of multiple kinds of holes each of which diameter is different from each other, and a pair of electrodes is provided to each kind of holes.

8. A particulate matter detection sensor according to claim 1, wherein
the sensor element is accommodated in a cover having an aperture and is disposed in an exhaust pipe of an internal combustion engine, and
the particulate matter detector portion is disposed in such a manner as to be exposed to an exhaust gas emitted from the engine.

9. A particulate matter detection sensor according to claim 1, wherein
the sensor element has a heater portion including a heater electrode for heating the particulate matter detection portion.
